(19) United States
(12) Patent Application Publication
(10) Pub. No.: US 2009/0185004 A1
(43) Pub. Date: Jul. 23, 2009

(54) DROPLET DISCHARGE HEAD AND PATTERN FORMING DEVICE

(75) Inventor: Yuji IWATA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/353,291

(22) Filed: Jan. 14, 2009

(30) Foreign Application Priority Data
Jan. 17, 2008 (JP) 2008-007660

(51) Int. Cl. B41J 2/14; B41J 29/38

(52) U.S. Cl. 347/47; 347/9

(57) ABSTRACT

A droplet discharge head includes: a droplet discharge head; and a nozzle plate that has a nozzle and is provided to the droplet discharge head. The nozzle plate is made of a peltier element. A droplet of a functional liquid containing a functional material is sequentially discharged from the nozzle to a substrate so as to form a pattern on a surface of the substrate.

### BACKGROUND

1. Technical Field

The present invention relates to a droplet discharge head and a pattern forming device.

2. Related Art

Conventionally, there has been known a method for forming a linear pattern on a substrate by using a droplet discharge device. In the method, the droplet discharge device discharges droplets of a functional liquid. For example, refer to JP-A-2005-34835.

Generally, the droplet discharge device includes a substrate placed on a stage, a droplet discharge head discharging droplets of a functional liquid containing a functional material to the substrate, and a mechanism moving the substrate (stage) and the droplet discharge head relatively and two-dimensionally. The device disposes the droplets discharged from the droplet discharge head at any position on a surface of the substrate. In this case, each of the droplets discharged on the surface of the substrate is sequentially disposed in such a manner that the spreading range of each droplet overlaps with each other. As a result, without any gap between the droplets, there can be formed a linear pattern covered with the functional liquid on the surface of the substrate.

In order to form high precision patterns, it is preferable that a droplet landed on the substrate be dried in a short time and then a subsequent droplet be landed. That is, the substrate is preferably heated so as to increase a drying speed of the landed droplet.

On the other hand, the spacing distance is very narrow between a nozzle formed surface of the droplet discharge head and the substrate. Accordingly, the droplet discharge head is heated by heat from the heated substrate when droplets are discharged to the substrate so as to form a pattern while the substrate is heated. The heat causes the following problems: the functional liquid discharged from the droplet discharge head is heated, resulting in increasing the viscosity; nozzle pitches vary due to the thermal expansion of a nozzle plate; and a discharge amount varies due to a drying of a solution stuck inside the droplet discharge head. As a result, patterns cannot be formed with high accuracy.

In order to cope with the problems, JP-A-2004-223914 discloses a technique in which a droplet discharge head is cooled with a peltier element to suppress a drying of the solution stuck inside the droplet discharge head.

In JP-A-2004-223914, however, the peltier element is fixed to the side face of the droplet discharge head. Thus, this structure does not achieve sufficient cooling effect with the peltier element because heat from the heated substrates transmits to the droplet discharge head through the nozzle plate facing the substrate. The above-described problems still remain, such as a decreasing of the viscosity of the functional liquid.

### SUMMARY

An advantage of the invention is to provide a droplet discharge head and a pattern forming device both in which the droplet discharge head is efficiently cooled.

According to a first aspect of the invention, a droplet discharge head includes: a droplet discharge head; and a nozzle plate that has a nozzle and is provided to the droplet discharge head. In the head, the nozzle plate is made of a peltier element. The droplet discharge head sequentially discharges a droplet of a functional liquid containing a functional material from the nozzle to a substrate so as to form a pattern on a surface of the substrate.

The droplet discharge head can block off heat transmitted through the nozzle plate, preventing the functional liquid from being heated by outside heat. As a result, the fluctuation of the discharge amount can be lowered without being influenced by outside temperature. Employing the nozzle plate made of the peltier element allows simplifying the structure as well as reducing the platen gap.

In the head, the nozzle plate made of the peltier element may include a cooling portion and a heat generating portion and be provided to the droplet discharge head so that the cooling portion faces a side adjacent to the droplet discharge head while the heat generating portion faces a side adjacent to the substrate.

The droplet discharge head can cool the functional liquid supplied to the droplet discharge head as well as heat the substrate.

In the droplet discharge device, the substrate may be a low-temperature firing sheet including ceramic particles and resin, and the functional liquid may be a metal ink in which metal particles are dispersed as the functional material.

The droplet discharge head can prevent the metal ink in which the metal particles are dispersed from being heated by outside heat. As a result, the discharge amount does not fluctuate.

According to a second aspect of the invention, a pattern forming device includes: a droplet discharge head; a heating unit that heats a substrate; a nozzle plate that has a nozzle and is made of a peltier element and is provided to the droplet discharge head; a peltier element driving circuit that supplies a driving current to the nozzle plate made of the peltier element; and a controller that drives and controls the peltier element driving circuit so as to cool a side adjacent to the droplet discharge head and heat a side adjacent to the substrate. The pattern forming device sequentially discharges a droplet of a functional liquid containing a functional material to the substrate so as to form a pattern on a surface of the substrate.

The pattern forming device can block off heat transmitted through the nozzle plate, preventing the functional liquid from being heated by outside heat. Accordingly, the fluctuation of the discharge amount can be lowered without being influenced by outside temperature, enabling a pattern to be formed with high accuracy.

In the pattern forming device, the substrate may have a circuit element mounted thereon and a wiring line electrically connected to the circuit element, and the droplet discharge head may discharge the droplet so as to form a pattern of the wiring line on the substrate.

The pattern forming device can form a wiring pattern on the substrate with high accuracy.

In the pattern forming device, the substrate may be a low-temperature firing sheet including ceramic particles and resin, and the functional liquid may be a metal ink in which metal particles are dispersed as the functional material.

The pattern forming device can form a wiring pattern on the low-temperature firing sheet with high accuracy.

### BRIEF DESCRIPTION OF THE DRAWINGS

The invention will be described with reference to the accompanying drawings, wherein like numbers reference like elements.

FIG. 1 is a sectional side view of a circuit module.

FIG. 2 is a whole perspective view of a droplet discharge device.

FIG. 3 is a bottom view of the droplet discharge head.

FIG. 4 is a sectional side view of a principal part of the droplet discharge head.

FIG. 5 is an electrical circuit block diagram explaining an electrical structure of the droplet discharge device.

### DESCRIPTION OF EXEMPLARY EMBODIMENT

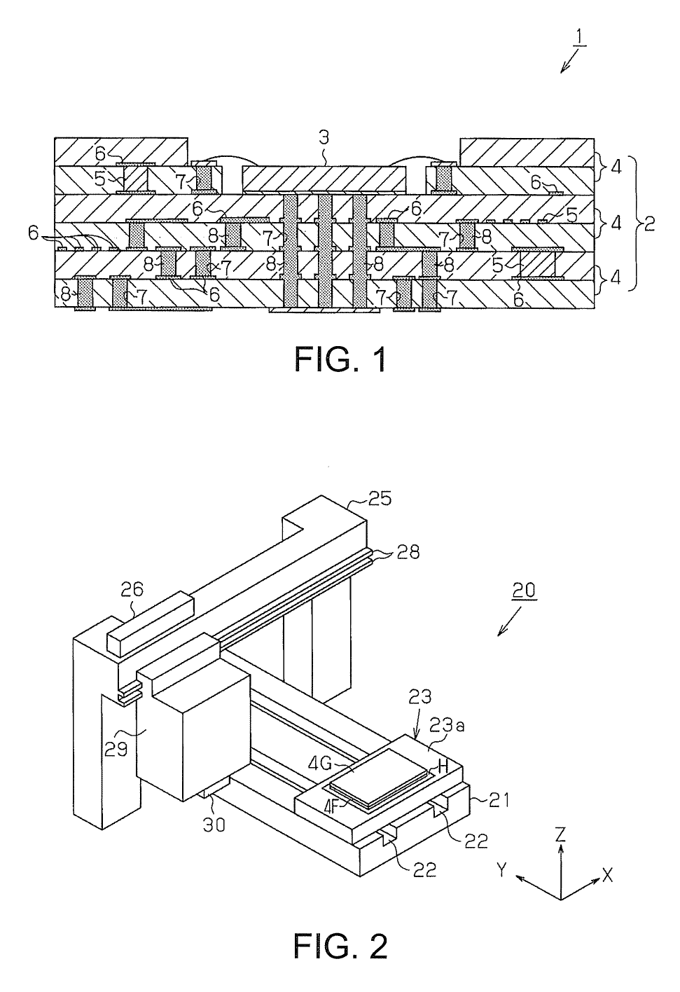

An embodiment of the invention will be described with reference to FIGS. 1 to 5. In a circuit module in which a semiconductor chip is built in a low temperature co-fired ceramic (LTCC) multilayer substrate, the invention is embodied in forming wiring patterns drawn on a plurality of low-temperature firing sheets (green sheets) included in the LTCC multilayer substrate.

First, the circuit module is described in which the semiconductor chip is mounted on the LTCC multilayer substrate. FIG. 1 is a sectional view of a circuit module 1. The circuit module 1 includes an LTCC multilayer substrate 2 and a semiconductor chip 3. The LTCC multilayer substrate 2 is formed into a board shape. The semiconductor chip 3 is connected to an upper side of the LTCC multilayer substrate 2 by wire bonding.

The LTCC multilayer substrate 2 is a laminated body of a plurality of low-temperature fired substrates 4 each of which is formed into a sheet shape. Each low-temperature fired substrate 4 is a sintered body formed from a glass ceramic material (e.g., a mixture of a glass component such as borosilicate alkali oxide and a ceramic component such as alumina). Thickness of each low-temperature fired substrate 4 is several hundred micrometers.

As for the low-temperature fired substrate 4, one before sintering is referred to as a green sheet 4G (refer to FIGS. 2 and 4) serving as a low-temperature firing sheet. The green sheet 4G is formed as follows: a powder of a glass ceramic based material and a dispersion medium are mixed with a binder, a foam stabilizer, and the like so as to make slurry; and the slurry is shaped in a plate shape and dried.

In each low-temperature fired substrate 4, various circuit elements 5, internal wiring lines 6, a plurality of via holes 7, and via wiring lines 8 are formed based on a circuit design. The various circuit elements 5 include resistive elements, capacitive elements, and coil elements, and the like. The internal wiring lines 6 electrically connect each of the circuit elements 5. The via holes 7 have a predetermined hole diameter (e.g., 20 μm) and are formed in a stack via structure or a thermal via structure. The via holes 7 are filled with the via wiring lines 8.

Each internal wiring line 6 on each low-temperature fired substrate 4 is a sintered body formed from metal fine particles of metal, such as silver and silver alloys. The internal wiring lines 6 are formed by a wiring pattern forming method using a droplet discharge device 20 shown in FIG. 2 as a pattern forming device.

FIG. 2 is a whole perspective view to explain the droplet discharge device 20.

The droplet discharge device 20 includes a base 21 formed in a rectangular parallelepiped shape. A pair of guide grooves 22 is formed on an upper surface of the base 21 extending in a longitudinal direction (an arrow Y direction) of the base 21. A stage 23 is provided above the guide grooves 22. The stage 23 moves in the arrow Y direction and a direction opposite to the arrow Y direction along the guide grooves 22.

The green sheet 4G, which is the low-temperature fired substrate 4 before sintering, is placed on the stage 23. A carrier film 4F is releasably bonded to a back surface of the green sheet 4G placed on the stage 23.

The carrier film 4F supports the green sheet 4G in a drawing step and in the subsequent steps. The carrier film 4F may be a plastic film having, for example, an excellent peeling property with respect to the green sheet 4G and a mechanical resistance in each step. The examples of the carrier film 4F may include a polyethylene terephthalate film, a polyethylene naphthalate film, a polyethylene film, and a polypropylene film.

The green sheet 4G is a layer made of a glass ceramic composition containing glass ceramic powders, binders, and the like. The green sheet 4G is formed as a layer having a thickness of several dozen μm in a case where a capacitor element is formed as the circuit element 5, and a thickness of 100 μm to 200 μm in other layers. The green sheet 4G is formed by a sheet forming method, such as a doctor blade method and a reverse roll coater method. The green sheet 4G is obtained by applying a glass ceramic compound slurried with a dispersion medium on the carrier film 4F and drying the applied film until the film can be handled.

Examples of the dispersion medium may include a surfactant or a silane coupling agent. Any dispersion medium can be used as long as it evenly disperses the glass ceramic powders.

The glass ceramic powders have an average particle size of 0.1 μm to 5 μm. For example, glass composite ceramic may be used in which borosilicate based glass and a ceramic powder such as alumina and forsterite are mixed. The glass ceramic powder may be made from crystallized glass ceramic containing ZnO—MgO—Al₂O₃—SiO₂ crystallized glass or non-vitreous ceramic containing a BaO—Al₂O₃—SiO₂ ceramic powder or an Al₂O₃—CaO—SiO₂—MgO—B₂O₃ ceramic powder.

The binder functions as a binding material of the glass ceramic powders, and is an organic polymer that is decomposed in a subsequent firing step and easily removed. The binder may be made of binder resin, such as butyral resin, acrylic resin, and cellulose resin. Examples of the acrylic binder resin may include a homopolymer of (metha)acrylate compound such as alkyl(metha)acrylate, alkoxyalkyl(metha)acrylate, polyalkylene glycol(metha)acrylate, and cycloalkyl(metha)acrylate. Examples of the acrylic binder resin may include a copolymer obtained from two or more types of the (metha)acrylate compounds and a copolymer obtained from the (metha)acrylate compound and another copolymerizable monomer such as unsaturated carbonic acids.

The binder may contain a plasticizer, such as an adipate ester plasticizer, a phthalate ester plasticizer such as dioctylphthalate (DOP) and dibutylphthalate (DBP), and a glycol ester plasticizer.

A rubber heater H serving as a heating unit is disposed on an upper surface 23a of the stage 23. The green sheet 4G placed on the stage 23 is heated to a predetermined temperature with the rubber heater H. The green sheet 4G placed on the stage 23 is positioned to the stage 23, and carried in the arrow Y direction and the direction opposite to the arrow Y direction.

As shown in FIG. 2, a guide member 25 having a gate shape straddles and stands over the base 21 in a direction (an arrow X direction) perpendicular to the arrow Y direction. On an upper surface of the guide member 25, an ink tank 26 is disposed extending in the arrow X direction. The ink tank 26 stores a metal ink F (refer to FIG. 4), and the ink tank 26 supplies a droplet discharge head (hereinafter, simply referred to as a discharge head) 30 with the stored metal ink F by applying a predetermined pressure. The metal ink F supplied to the discharge head 30 is discharged towards the green sheet 4G as a droplet Fb (refer to FIG. 4).

As the metal ink F, a dispersive metal ink can be used in which metal fine particles, for example, having a diameter of a few nm and serving as a functional material are dispersed in a solvent.

Examples of the metal fine particles for the metal ink F include gold (Au), silver (Ag), copper (Cu), aluminum (Al), palladium (Pd), manganese (Mn), titanium (Ti), tantalum (Ta), nickel (Ni), oxides of them, and fine particles of a superconductor. Preferably, the metal fine particles have a diameter of 1 nm to 0.1 μm inclusive. If the diameter is larger than 0.1 μm, any discharge nozzle N of the discharge head 30 may be clogged. In contrast, if the diameter is smaller than 1 nm, a volume ratio of a dispersant to the metal fine particles becomes greater, thereby excessively increasing the ratio of an organic substance in an obtained film.

Any dispersion medium can be used as long as it is capable of dispersing the above described metal fine particles and does not cause an aggregation. Examples of the dispersion medium may include: aqueous solvents; alcohols such as methanol, ethanol, propanol, and butanol; hydro-carbon compounds such as n-heptane, n-octane, decane, dodecane, tetradecane, toluene, xylene, cymene, durene, indene, dipentene, tetrahydronaphthalene, decahydronaphthalene, and cyclohexylbenzene; polyols such as ethylene glycol, diethylene glycol, triethylene glycol, glycerin, and 1,3-propanediol; ether compounds such as polyethylene glycol, ethylene glycol dimethyl ether, ethylene glycol diethyl ether, ethylene glycol methyl ethyl ether, diethylene glycol dimethyl ether, diethylene glycol diethyl ether, diethylene glycol methyl ethyl ether, 1,2-dimethoxyethane, bis (2-methoxyethyl) ether, and p-dioxane; and polar compounds such as propylene carbonate, gamma-butyrolactone, N-methyl-2-pyrrolidone, dimethylformamide, dimethyl sulfoxide, cyclohexanone, and ethyl lactate. Among them, water, alcohols, hydrocarbon compounds, and ether compounds are preferably used in terms of particulate dispersibility, dispersion-liquid stability, and applicability to a droplet discharge method, and more preferably, water and hydrocarbon compounds are used.

After the metal ink F lands on the green sheet 4G, a solvent or a part of a dispersion medium of the metal ink F evaporates from the surface. At this time, the evaporation of the solvent and the dispersion medium is enhanced since the green sheet 4G is heated with the rubber heater H.

Then, the metal ink F landed on the green sheet 4 increases its viscosity from the outer edge of the surface as it is dried. That is, the concentration of solid matter (particles) in the outer circumference reaches a saturated concentration faster than that in the center portion, so that the metal ink F increases its viscosity from the outer edge of the surface. The metal ink F having the viscosity increased at the outer edge stops itself from spreading along a surface direction of the green sheet 4G (performs pinning). The metal ink F that has been pinned is fixed onto the green sheet 4G, so that the outer diameter of the droplet Fb does not change. Therefore, even when the droplet Fb is newly landed and overlapped with the pinned metal ink F, the pinned metal ink F is not pulled toward the newly landed droplet Fb.

The guide member 25 is provided with a pair of upper and lower guide rails 28 extending along the arrow X direction over roughly whole width of the guide member 25. The pair of upper and lower guide rails 28 is provided with a carriage 29. The carriage 29 moves in the arrow X direction and a direction opposite to the arrow X direction by being guided with the guiding rails 28. The carriage 29 is provided with the droplet discharge head 30.

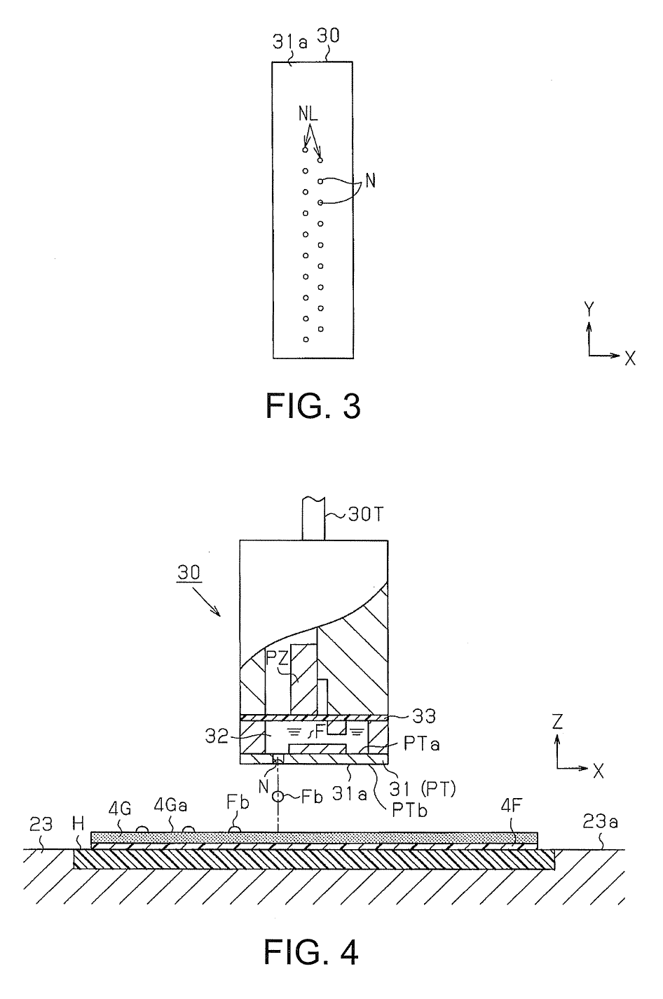

FIG. 3 is a bottom view of the discharge head 30 viewed from a side adjacent to the green sheet 4G. FIG. 4 is a sectional view of a principal part of the discharge head 30. A nozzle plate 31 is provided at the lower side of the discharge head 30.

The bottom surface (a nozzle formed surface 31a) of the nozzle plate 31 is formed roughly parallel to an upper surface (a discharged surface 4Ga) of the green sheet 4G. When the green sheet 4G is positioned directly below the discharge head 30, a predetermined distance (a platen gap, e.g., 600 μm) is maintained between the nozzle formed surface 31a and the discharged surface 4Ga.

The nozzle plate 31 is made of a peltier element PT. The peltier element PT is composed of a cooling portion PTa and a heat generating portion PTb. The nozzle plate 31 (peltier element PT) is fixed to the discharge head 30 so that the cooling portion PTa faces a side adjacent to the discharge head 30 while the heat generating portion PTb faces a side adjacent to the green sheet 4G.

According to the structure, the nozzle plate 31 made of the peltier element PT cools the discharge head 30 with the cooling portion PTa. Heat generated from the heat generating portion PTb is radiated to the green sheet 4G. In other words, heat is radiated from the nozzle plate 31 to the discharged surface 4Ga.

In FIG. 3, the nozzle formed surface 31a is provided with a pair of nozzle rows NL composed of a plurality of nozzles N arranged along Y arrow direction. Each nozzle row of the pair of nozzle rows NL has 180 nozzles N per inch. In FIG. 3, only 10 nozzles N per row are shown for purpose of explanation.

In the pair of nozzle rows NL, each gap between nozzles N of one nozzle row NL is filled with one of the nozzles N of the other nozzle row NL when they are viewed in the arrow Y direction. In other words, the discharge head 30 includes 180 nozzles times two or 360 nozzles N per inch in the arrow Y direction (maximum resolution is 360 dpi).

In FIG. 4, a supply tube 30T is connected to the upper side of the discharge head 30. The supply tube 30T is set extending in an arrow Z direction. The supply tube 30T supplies the discharge head 30 with the metal ink F from the ink tank 26.

A cavity 32 communicating with the supply tube 30T is formed on the upper side of each nozzle N. The cavity 32 stores the metal ink F from the supply tube 30T and supplies the corresponding nozzle N with the metal ink F. The metal ink F is cooled with the cooling portion PTa of the peltier element PT since the nozzle plate 31 made of the peltier element PT is disposed.

A vibrating plate 33 is bonded to the upper side of the cavity 32. The vibrating plate 33 vibrates in the arrow Z direction and a direction opposite to the arrow Z direction, and increases and decreases the volume within the cavity 32. Hereinafter, the arrow Z direction and the direction opposite to the arrow Z direction are referred to as the upper and lower directions. A piezoelectric element PZ corresponding to the nozzle N is disposed on the upper side of the vibrating plate 33. The piezoelectric element PZ contracts and expands in the upper and lower directions, and vibrates the vibrating plate 35 in the upper and lower directions. The vibrating plate 33 vibrates and forms the metal ink F into the droplet Fb of a predetermined size and discharges the droplet Fb from the corresponding nozzle N. The discharged droplet Fb flies from the corresponding nozzle N in the direction opposite to the arrow Z direction and lands on the discharged surface 4Ga of the green sheet 4G.

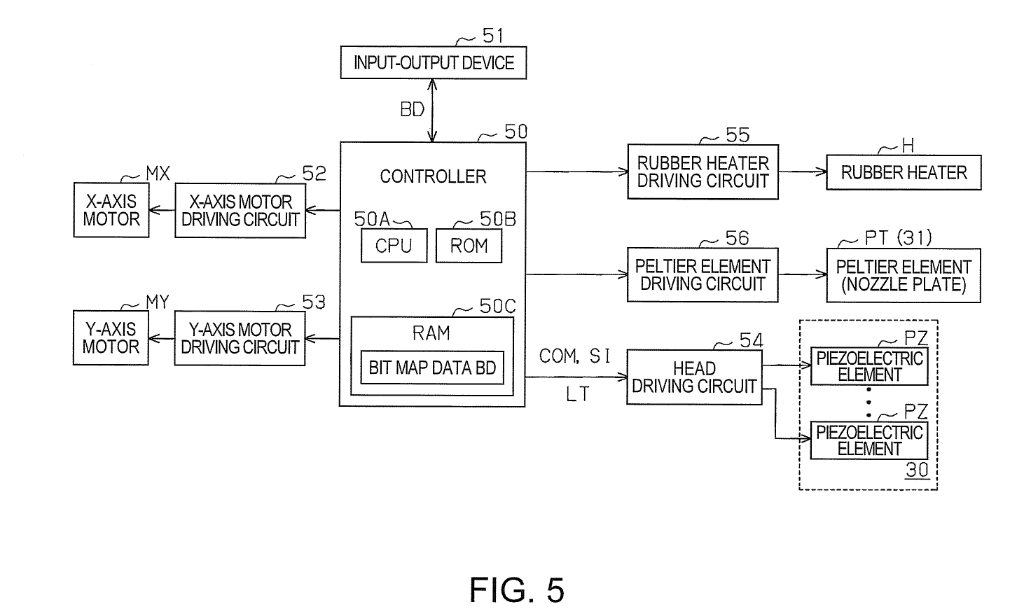

An electrical structure of the droplet discharge device 20 will now be described with reference to FIG. 5.

In FIG. 5, a controller 50 serving as a control unit includes a CPU 50A, a ROM 50B, and a RAM 50C. The controller 50 carries out a conveying process of the stage 23, a conveying process of the carriage 29, a droplet discharging process of the discharge head 30, a heating process of the rubber heater H, a driving process of the peltier element PT (the nozzle plate 31), and the like in accordance with various data and various control programs that are stored therein.

The controller 50 is coupled to an input-output unit 51 having various operation switches and displays. The input-output unit 51 displays processing states of the various processes carried out by the droplet discharge device 20. The input-output unit 51 generates bitmap data BD used to form the internal wiring lines 6 so as to input it to the controller 50.

The bitmap data BD defines on and off states of each piezoelectric element PZ based on a value of each bit (0 or 1). The bitmap data BD defines whether the droplet Fb for a wiring line is discharged at each position on a drawing plane (the discharged surface 4Ga) over which the discharge head 30 (each nozzle N) passes. In other words, the bitmap data BD is used to enable the droplet Fb for a wiring line to be discharged at a target position defined on the discharged surface 4Ga for forming the internal wiring lines 6.

The controller 50 is coupled to an X-axis motor driving circuit 52. The controller 50 outputs a driving control signal to the X-axis motor driving circuit 52. The X-axis motor driving circuit 52 responds to the driving control signal received from the controller 50 to normally or reversely rotate an X-axis motor MX for conveying the carriage 29. The controller 50 is coupled to a Y-axis motor driving circuit 53. The controller 50 outputs a driving control signal to the Y-axis motor driving circuit 53. The Y-axis motor driving circuit 53 responds to the driving control signal received from the controller 50 to normally or reversely rotate a Y-axis motor MY for conveying the stage 23.

The controller 50 is coupled to a head driving circuit 54. The controller 50 outputs a discharge timing signal LT synchronized with a predetermined discharge frequency to the head driving circuit 54. The controller 50 synchronizes a driving voltage COM for driving each piezoelectric element PZ with the discharge frequency so as to output it to the head driving circuit 54.

The controller 50 generates a pattern formation control signal SI synchronized with a predetermined frequency by using the bitmap data BD, and then serially transfers the pattern formation control signal SI to the head driving circuit 54. The head driving circuit 54 sequentially serial/parallel converts the pattern formation control signal SI received from the controller 50 corresponding to each piezoelectric element PZ. The head driving circuit 54 latches the pattern formation control signal SI that is serial/parallel converted at every time when the discharge timing signal LT is received from the controller 50. Then, the head driving circuit 54 supplies the driving voltage COM to each piezoelectric element PZ selected by the pattern formation control signal SI.

The controller 50 is coupled to a rubber heater driving circuit 55. The controller 50 outputs a driving control signal to the rubber heater driving circuit 55. The rubber heater driving circuit 55 drives the rubber heater H and controls the rubber heater H to heat the green sheet 4G, which is placed on the stage 23, to a predetermined temperature in response to the driving control signal received from the controller 50.

According to the embodiment, the predetermined temperature of the green sheet 4G (i.e., the temperature of the discharged surface 4Ga) is regulated at a temperature equal to or more than the temperature of the metal ink F at a time when the metal ink F is discharged from the discharge head 30, and less than a boiling point of a liquid composition included in the metal ink F (less than the lowest boiling point temperature among the liquid compositions). In other words, the green sheet 4G is heated to a temperature equal to or more than the temperature of the metal ink F at a time when the metal ink F is discharged from the discharge head 30. The droplet Fb landed on the green sheet 4G is quickly heated and dried while the droplet Fb is not dried by the discharge head 30 at a time when it is discharged. The green sheet 4G is also heated to a temperature less than the boiling point of the droplet Fb so that bumping of the droplet Fb landed does not occur on the green sheet 4G.

The controller 50 is coupled to a peltier element driving circuit 56. The controller 50 outputs a driving control signal to the peltier element driving circuit 56. The peltier element driving circuit 56 responds to the driving control signal received from the controller 50 to drive and control the peltier element PT (the nozzle plate 31) by flowing a driving current.

In the embodiment, the peltier element PT is driven and controlled while the discharge head 30 discharges the droplet Fb to the green sheet 4G heated.

That is, the discharge head 30 made of the peltier element PT is cooled with the nozzle plate 31 while the discharge head 30 discharges the droplet Fb so that the temperature increase of the metal ink F stored in the cavity 32 is suppressed.

Next, a method for forming a wiring line pattern on the green sheet 4G by using the droplet discharge device 20 will be described.

As shown in FIG. 2, the green sheet 4G is placed on the stage 23 so that the discharged surface 4Ga faces upwards. At this time, the stage 23 disposes the green sheet 4G in the direction opposite to the arrow Y direction with respect to the carriage 29. The green sheet 4G has the via holes 7, through which the via wiring lines 8 are laid. The internal wiring lines 6 are formed to the discharged surface 4Ga.

The controller 50 receives the bitmap data BD for forming the internal wiring lines 6 from the input-output unit 51. The controller 50 stores the bitmap data BD, outputted from the input-output unit 51, for forming the internal wiring lines 6.

Next, the controller 50 drives the Y-axis motor MY, via the Y-axis motor driving circuit 53, to carry the stage 23 so that the discharge head 30 passes directly over a predetermined position on the green sheet 4G in the arrow X direction. The controller 50, then, drives the X-axis motor MX, via the X-axis motor driving circuit 52, so that the discharge head 30 starts a scan movement (reciprocating movement). At this time, the controller 50 drives the rubber heater H provided on the stage 23, via the rubber heater driving circuit 55, to control the rubber heater H so that the green sheet 4G, which is placed on the stage 23, is heated to a predetermined temperature.

When the discharge head 30 starts a scan movement (reciprocating movement), the controller 50 generates the pattern formation control signal SI based on the bitmap data BD so as to output the pattern formation control signal SI and the drive voltage COM to the head driving circuit 54. In other words, the controller 50 drives and controls each piezoelectric element PZ, via the head driving circuit 54, so that the droplet Fb is discharged from a selected nozzle N at every time when the discharge head 30 is positioned over a landing position to form the internal wiring lines 6. As shown in FIG. 4, the discharged droplet Fb lands sequentially on the landing position to form the internal wiring line 6 designated.

When the discharge head 30 is moved as a reciprocating movement in the arrow X direction, the controller 50 drives the nozzle plate 31 made of the peltier element PT of the discharge head 30. Accordingly, the discharge head 30 is cooled with the cooling portion PTa of the nozzle plate 31 made of the peltier element PT while discharging the droplet Fb and moving as a reciprocating movement in the arrow X direction. That is, the nozzle plate 31 blocks off the radiation from the green sheet 4G heated. As a result, the metal ink F stored in the cavity 32 is not heated with the nozzle plate 31 receiving the radiation from the green sheet 4G heated.

Meanwhile, the droplet Fb landed on the green sheet 4G is heated by the radiation from the heat generating portion PTb of the nozzle plate 31 made of the peltier element PT and drying the droplet Fb is enhanced. That is, since the green sheet 4G is heated with the rubber heater H and the peltier element PT (the nozzle plate 31), the droplet Fb landed is immediately dried.

When the discharge head 30 completes a scan movement from one edge of the green sheet 4G to the other, or in other words, when the discharge head 30 moves as a scan movement (reciprocating movement) in the arrow X direction and a first operation with the droplet Fb is completed, the controller 50 drives the Y-axis motor MY, via the Y-axis motor driving circuit 53, so as to carry the stage 23 in the arrow Y direction by a predetermined amount, and then moves the discharge head 30 in the direction opposite to the arrow X direction as a scan movement (reciprocating movement). As a result, the droplet Fb is ready to be discharged onto a new position on the green sheet 4G to form the internal wiring line 6.

When the discharge head 30 starts a scan movement (reciprocating movement), the controller 50 drives and controls each piezoelectric element PZ, via the head driving circuit 54, based on the bitmap data BD in the same manner as described above so that the droplet Fb is discharged from a selected nozzle N at every time when the discharge head 30 is positioned over a landing position to form the internal wiring line 6.

When the discharge head 30 is moved as a reciprocating movement in the direction opposite to the arrow X direction, the controller 50 drives the nozzle plate 31 made of the peltier element PT of the discharge head 30. That is, in the same manner as the discharge head 30 is moved in the arrow X direction, the discharge head 30 is cooled with the cooling portion PTa of the peltier element PT (the nozzle plate 31) while discharging the droplet Fb and moving in the direction opposite to the arrow X direction as a reciprocating movement, and the droplet Fb landed on the green sheet 4G is heated by the radiation from the heat generating portion PTb of the peltier element PT (the nozzle plate 31) and drying the droplet Fb is enhanced.

Subsequently, operations are repeated in which the discharge head 30 reciprocates in the arrow X direction and the direction opposite to the arrow X direction, the stage 23 is carried in the arrow Y direction, and the droplet Fb is discharged at a timing based on the bitmap data BD while the discharge head 30 reciprocates. As a result, a wiring line pattern is drawn on the green sheet 4G with the landed droplet Fb to form the internal wiring line 6.

Advantageous effects of the embodiment described above will be described below.

(1) According to the embodiment, the rubber heater H disposed on the stage 23 heats the green sheet 4G placed on the stage 23 to a predetermined temperature. As a result, the droplet Fb discharged from the discharge head 30 and landed on the green sheet 4G is dried rapidly.

(2) According to the embodiment, the nozzle plate 31 is made of the peltier element PT. The nozzle plate 31 (the peltier element PT) is fixed to the discharge head 30 so that the cooling portion PTa of the peltier element PT faces a side adjacent to the discharge head 30 while the heat generating portion PTb of the peltier element PTb faces a side adjacent to the green sheet 4G. Accordingly, the metal ink F stored in the cavity 32 is not heated with the nozzle plate 31 receiving the radiation from the green sheet 4G heated. This prevents the viscosity of the metal ink F discharged from the droplet discharge head 30 from being lowered by heating, resulting in the discharging amount being not fluctuated. As a result, a pattern can be drawn with high accuracy.

Since the nozzle plate 31 is made of the peltier element PT, the number of parts included in the head does not increase. As a result, the structure is simplified and, in addition, the platen gap can be reduced.

(3) In the embodiment, the nozzle plate 31 (the peltier element PT) is fixed to the discharge head 30 so that the heat generating portion PTb of the peltier element PTb faces a side adjacent to the green sheet 4G. Accordingly, the droplet Fb landed on the green sheet 4G is heated by the radiation from the heat generating portion PTb of the nozzle plate 31 made of the peltier element PT and drying the droplet Fb is enhanced.

The above mentioned embodiment may be changed as follows.

While the green sheet 4G is heated with the rubber heater H in the embodiment, other heating units, such as an ultra-red-ray heater may be used for the heating.

In the embodiment, the functional liquid is embodied as the metal ink F. The functional liquid is not limited to this, but may be embodied as a functional liquid including a liquid crystal material, for example. In other words, any functional liquid may be embodied as long as it is discharged for forming a pattern.

In the embodiment, the substrate is embodied as the green sheet 4G. The substrate is not limited to this, but may be embodied as a glass substrate, a polyimide substrate, a glass epoxy substrate, and the like.

In the embodiment, the droplet discharge unit is embodied as the droplet discharge head 30 of a piezoelectric element driving system. Other than that, for example, the droplet discharge head may be embodied as a discharge head of a resistance heating system or an electrostatic driving system.

The entire disclosure of Japanese Patent Application No. 2008-7660, filed Jan. 17, 2008 is expressly incorporated by reference herein.

What is claimed is:

1. A droplet discharge head, comprising:
a droplet discharge head; and
a nozzle plate that has a nozzle and is provided to the droplet discharge head, wherein: the nozzle plate is made of a peltier element; and a droplet of a functional liquid containing a functional material is sequentially discharged from the nozzle to a substrate so as to form a pattern on a surface of the substrate.

2. The droplet discharge head according to claim 1, wherein the nozzle plate made of the peltier element includes a cooling portion and a heat generating portion, and is provided to the droplet discharge head so that the cooling portion faces a side adjacent to the droplet discharge head while the heat generating portion faces a side adjacent to the substrate.

3. The droplet discharge head according to claim 1, wherein: the substrate is a low-temperature firing sheet including ceramic particles and resin; and the functional liquid is a metal ink in which metal particles are dispersed as the functional material.

4. A pattern forming device, comprising:
a droplet discharge head:
a heating unit that heats a substrate;
a nozzle plate that has a nozzle and is made of a peltier element and is provided to the droplet discharge head;
a peltier element driving circuit that supplies a driving current to the nozzle plate made of the peltier element; and
a controller that drives and controls the peltier element driving circuit so as to cool a side adjacent to the droplet discharge head and heat a side adjacent to the substrate, wherein a droplet of a functional liquid containing a functional material is sequentially discharged to the substrate so as to form a pattern on a surface of the substrate.

5. The pattern forming device according to claim 4, wherein: the substrate has a circuit element mounted thereon and a wiring line electrically connected to the circuit element; and the droplet discharge head discharges the droplet so as to form a pattern of the wiring line on the substrate.

6. The pattern forming device according to claim 5, wherein: the substrate is a low-temperature firing sheet including ceramic particles and resin; and the functional liquid is a metal ink in which metal particles are dispersed as the functional material.
